(19) United States
(12) Patent Application Publication
(10) Pub. No.: US 2012/0293740 A1
(43) Pub. Date: Nov. 22, 2012

(54) ANTIMICROBIAL CASE FOR MEDICAL MONITOR

(75) Inventor: Kenzo SUDO, San Jose, CA (US)

(73) Assignee: ADVAN Int'l Corp., Fremont, CA (US)

(21) Appl. No.: 13/109,288

(22) Filed: May 17, 2011

(51) Int. Cl. G02F 1/1335; B65D 90/00

(52) U.S. Cl. 349/61; 206/524.6

(57) ABSTRACT

Disclosed is an antimicrobial medical monitor case which has antimicrobial properties by adding a zinc phosphate glass powder to a synthetic resin for a monitor case. The antimicrobial case includes 99.4 to 99.8 wt % of a plastic resin and 0.2 to 0.4 wt % of a zinc phosphate glass powder represented by Formula:

⅓Ag₂O·(P₂O₆·ZnO)m·(2CaO·3B₂O₈)n,
where m=10, and n=1.1 to 1.4.

### BACKGROUND

1. Technical Field

Embodiments of the invention relate to an antimicrobial medical monitor case and, more particularly, to an antimicrobial medical monitor case that has antimicrobial properties by adding a zinc phosphate glass powder to a synthetic resin for a monitor case.

2. Description of the Related Art

Since the field of medicine is a very important and unique area dealing with human life, medicine is at the leading edge of technology where various fields are tested and applied. A variety of techniques are employed in the field of medicine such as chemical and biological techniques to develop new substances and materials, mechanical techniques to develop medical equipment, surgical robots or capsulated micro-robots, electric and electronic techniques to develop various types of diagnostic and test equipment, IT techniques to lead ubiquitous medical care environments, and the like.

For example, in electric and electronic applications closely related to various types of diagnostic and test equipment, a display device for displaying diagnosis results of a patient with a disease using image information is widely used. As such a display device, a liquid crystal display (LCD), which is thin and light, is generally used.

Medical display devices are adopted in consideration of use environments. Since medical treatment frequently requires cooperation between doctors or nurses, moving quickly within a relatively limited space, it is important to efficiently arrange a variety of medical devices in the space. In particular, since it is necessary to accurately read image information regarding patient conditions displayed on a medical monitor, the medical monitor is positioned near medical workers.

The medical monitor case is formed of synthetic resins and needs to have antimicrobial properties since it is positioned near medical workers and patients.

### BRIEF SUMMARY

The present invention is directed to impart bacteriostatic activity to a case, which forms an appearance of a medical monitor and is frequently touched by medical workers and patients, thereby providing sanitation during medical treatment and therapy.

In accordance with one aspect of the invention, an antimicrobial case for a medical monitor includes 99.4 to 99.8% by weight (wt %) of a plastic resin and 0.2 to 0.4 wt % of a zinc phosphate glass powder represented by Formula 1:

⅓Ag₂O·(P₂O₆·ZnO)m·(2CaO·3B₂O₈)n,

wherein m=10 and n=1.1 to 1.4.

The zinc phosphate glass powder may have a true specific gravity of 2.45 to 2.55 and a bulk specific gravity of 0.78 to 0.82.

The plastic resin may include one selected from an acrylonitrile butadiene styrene (ABS) copolymer resin, a polypropylene (PP) resin, and a polycarbonate (PC) resin.

In accordance with another aspect of the invention, a medical monitor includes a liquid crystal display (LCD) panel displaying a flat image, a backlight unit emitting surface light to the LCD panel, a front case formed with an opening to expose the LCD panel, and a rear case coupled to the front case and covering the LCD panel and the backlight unit, wherein the front case and the rear case include 99.4 to 99.8% by weight (wt %) of a plastic resin and 0.2 to 0.4 wt % of a zinc phosphate glass powder represented by Formula 1.

### BRIEF DESCRIPTION OF THE DRAWINGS

The above and other aspects, features, and advantages of the invention will become apparent from the detailed description of the following embodiments in conjunction with the accompanying drawings:

FIG. 1 is a perspective view of a medical monitor including an antimicrobial case according to an exemplary embodiment of the present invention; and

FIG. 2 is a perspective view of the disassembled medical monitor including the antimicrobial case according to the exemplary embodiment of the present invention.

### DETAILED DESCRIPTION

Exemplary embodiments of the invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. The scope of the invention is limited only by the accompanying claims and equivalents thereof. Like components will be denoted by like reference numerals throughout the specification.

Further, the size and relative sizes of elements may be exaggerated for clarity. It will be understood that when an element is referred to as being “installed in or connected to” another element, it can be directly disposed on the other element, it can be separated a predetermined interval from the other element, or a third element may also be present therebetween to fix or connect it to the other element.

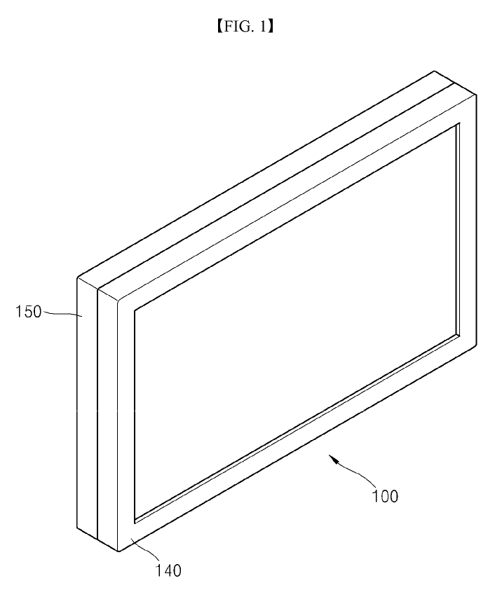

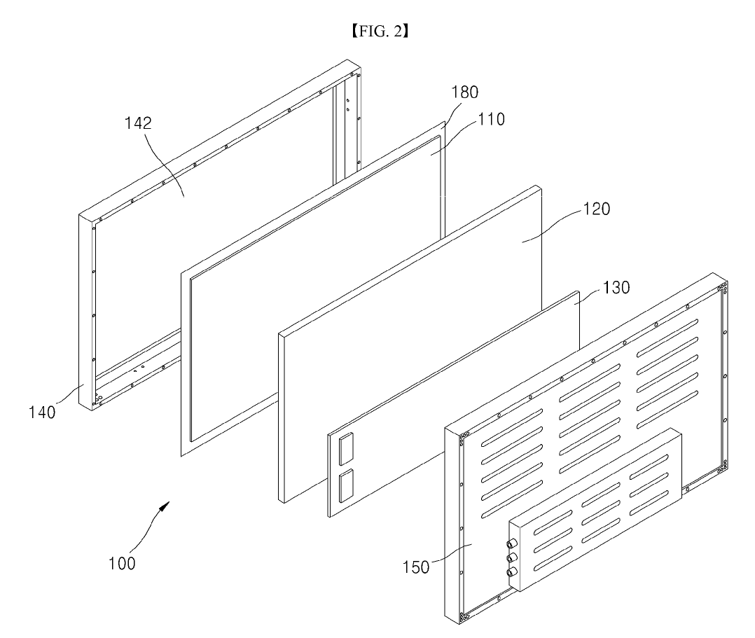

FIG. 1 is a perspective view of a medical monitor including an antimicrobial case according to an exemplary embodiment of the present invention, and FIG. 2 is a perspective view of the disassembled medical monitor including the antimicrobial case according to the exemplary embodiment of the present invention.

As shown in FIGS. 1 and 2, the medical monitor 100 according to the embodiment includes a liquid crystal display (LCD) panel 110, a backlight unit 120 disposed behind the LCD panel 110, a drive circuit unit 130 disposed behind the backlight unit 120, a front case 140 having an opening 142 to expose the LCD panel 110, and a rear case 150 coupled to the front case 140 and covering the LCD panel 110, the backlight unit 120 and the drive circuit unit 130. Further, the LCD panel 110 is protected by a reinforced glass 180. This configuration is general for an LCD monitor and a detailed description thereof will thus be omitted herein.

In the present embodiment, antimicrobial functions are imparted to a monitor case among components of the medical monitor, which is exposed to the outside and comes into direct contact with medical workers and patients.

The monitor case includes the front case 140 and the rear case 150. In the present embodiment, antimicrobial properties are imparted both to the front case 140 and to the rear case 150, thereby providing antimicrobial properties to the entire outside of the monitor touched by patients and medical workers. Hereinafter, the front case 140 and the rear case 150 are collectively referred to as a case.

The antimicrobial case for a medical monitor according to the present embodiment is manufactured by mixing a plastic resin with a small amount of zinc phosphate glass powder, thereby preventing growth of microorganisms such as bacteria or the like on the surface thereof.

The zinc phosphate glass powder is represented by Formula 1:

⅓Ag₂O·(P₂O₆·ZnO)m·(2CaO·3B₂O₈)n,

where m=10, and n=1.1 to 1.4.

The zinc phosphate glass powder is a white powder and may have a true specific gravity of 2.45 to 2.55, a bulk specific gravity of 0.78 to 0.82, an average particle size 3 to 5 μm, and a maximum particle diameter of 10 to 20 μm.

The zinc phosphate glass powder is a single product and provides material safety.

That is, exposure of zinc phosphate glass powder to the eye does not cause any harm. Further, the zinc phosphate glass powder does not cause any harm to the skin and can be washed off with water.

If the zinc phosphate glass powder has too a large particle size, the glass powder functions as a crack point, thereby reducing durability and deteriorating the quality of the case surface.

It is desirable that the plastic resin have formability, strength, durability, and thermal resistance.

Examples of the plastic resin may include, without being limited to, an acrylonitrile butadiene styrene (ABS) resin, a polypropylene (PP) resin, a polycarbonate (PC) resin, and the like.

The ABS copolymer resin is a styrene resin comprised of styrene, acrylonitrile and butadiene. The ABS copolymer resin generally has easy processability, high impact resistance and excellent thermal resistance. The ABS copolymer resin has a heat resistance of 93° C. and an impact resistance of 4.5 as compared with polyethylene having a heat resistance of 80° C. and an impact resistance of 0.8.

The ABS copolymer resin is generally prepared by mixing or blending a copolymer of acrylonitrile and butadiene and a copolymer of styrene and butadiene, so that a copolymer resin having properties of these copolymers is obtained. Since different combinations of components of the copolymers cause a delicate change in product performance, combinations of the copolymer components may be changed depending on purposes.

PP resin is produced along with ethylene when naphtha is decomposed in a petrochemical plant. The PP resin has an isotactic structure, in which methyl groups are regularly oriented in the same direction. The PP resin has a melting point of 165° C. and can be successively used at 110° under a load. The PP resin has a density of 0.9 to 0.91 and crystallinity, which is high but is decreased to 70% or less after molding.

PC resin is also referred to as polyester carbonate. An available thermoplastic resin is polycarbonate from bisphenol-A. PC resin is an engineering plastic which is transparent, non-toxic and self-extinguishable, has excellent mechanical properties, such as excellent impact resistance, and a good balance between thermal resistance, cold resistance and electrical properties. PC resin is prepared industrially by solvent polymerization through interfacial polycondensation of bisphenol-A and phosgene or by melt polymerization through transesterification of bisphenol-A and diphenyl carbonate. PC resin has a molecular weight of 20,000 or more.

The antimicrobial case of the medical monitor according to the embodiment includes 99.4 to 99.8% by weight (wt %) of one plastic resin selected from the ABS copolymer resin, the PP resin and the PC resin and 0.2 to 0.4 wt % of the zinc phosphate glass powder represented by Formula 1.

The case is manufactured by adding the zinc phosphate glass powder to a molten plastic resin and thoroughly stirring the mixture to uniformly disperse the zinc phosphate glass powder in the resin, followed by injection molding.

Here, the term “molten” does not refer to a complete liquid state, but means a state in which the resin has fluidity to mix with the powder and to be subjected to injection molding.

The zinc phosphate glass powder is used to impart antimicrobial properties to the plastic resin and is added in an amount suitable to provide antimicrobial effects without affecting mechanical properties.

When the amount of zinc phosphate glass powder is below 0.2 wt % based on the total weight of plastic resin, antimicrobial effects are not exhibited. When the amount of zinc phosphate glass powder exceeds 0.4 wt % based on the total weight of plastic resin, mechanical properties can be changed, since the zinc phosphate glass powder functions as a defect in the case, decreasing strength and durability.

Further, since excessive addition of the zinc phosphate glass powder brings about cost increase, it is desirable that the zinc phosphate glass powder be added in a proper amount to impart antimicrobial properties to the case of the medical monitor.

### EXAMPLE

Samples were prepared using a pure ABS copolymer resin in Comparative Example and using a mixture of an ABS copolymer resin and 0.4 wt % of a zinc phosphate glass powder represented by Formula 1 in Example, and quantitative analysis was performed using JIS Z 2801 on the samples to measure bacteriostatic activity.

In Example, 0.4 wt % of the zinc phosphate glass powder represented by Formula 1 was added to 99.6 wt % of molten ABS copolymer resin and thoroughly stirred by an agitator, followed by injection molding to prepare a sample.

The samples of Comparative Example and Example were inoculated with Escherichia coli NBRC 3972 and left at 35° C.±1° C. and at a relative humidity of 90% for 24 hours, followed by measurement of the number of bacteria.

The inoculated number of Escherichia coli NBRC 3972 was 2.3×10⁵/ml and the inoculated amount thereof was 0.4 ml.

In Comparative Example, the number of bacteria (A) increased to 2.2×10⁷/ml.

In Example, the number of bacteria (B) decreased to 6.6×10³/ml.

An antimicrobial index is log(A/B)=log(2.2×10⁷/ml/6.6×10³/ml)=3.5.

Based on the standards, a material having an antimicrobial index of 2.0 or greater is deemed to have bacteriostatic activity.

Accordingly, the zinc phosphate glass powder-added ABS copolymer resin is identified as having bacteriostatic activity against Escherichia coli NBRC 3972.

In a conventional monitor case having no antimicrobial properties, bacteria attached to the surface of the case may multiply, causing infections in patients and medical workers since the monitor case is used near the patients and medical workers. According to the present invention, antimicrobial properties are imparted to medical monitors, thereby providing a safe and sanitary medical environment.

As described above, according to the embodiments of the invention, antimicrobial properties are imparted to a monitor case to prevent multiplication of bacteria on the surface of the monitor which is used near medical workers and patients, thereby providing a sanitary medical environment.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. An antimicrobial case for a medical monitor comprising:
99.4 to 99.8% by weight (wt %) of a plastic resin; and
0.2 to 0.4 wt % of a zinc phosphate glass powder represented by Formula 1:
⅓Ag₂O·(P₂O₆·ZnO)m·(2CaO·3B₂O₈)n,
where m=10, and n=1.1 to 1.4.

2. The antimicrobial case of claim 1, wherein the zinc phosphate glass powder has a true specific gravity of 2.45 to 2.55.

3. The antimicrobial case of claim 1, wherein the zinc phosphate glass powder has a bulk specific gravity of 0.78 to 0.82.

4. The antimicrobial case of claim 1, wherein the plastic resin comprises one selected from an acrylonitrile butadiene styrene (ABS) copolymer resin, a polypropylene (PP) resin and a polycarbonate (PC) resin.

5. The antimicrobial case of claim 1, wherein the zinc phosphate glass powder has an average particle size of 3 to 5 μm and a maximum particle diameter of 10 to 20 μm.

6. A medical monitor comprising:
a liquid crystal display (LCD) panel displaying a flat image;
a backlight unit emitting surface light to the LCD panel;
a front case formed with an opening to expose the LCD panel; and
a rear case coupled to the front case and covering the LCD panel and the backlight unit,
the front case and the rear case comprising:
99.4 to 99.8 wt % of a plastic resin; and
0.2 to 0.4 wt % of a zinc phosphate glass powder represented by Formula 1:
⅓Ag₂O·(P₂O₆·ZnO)m·(2CaO·3B₂O₈)n,
where m=10, and n=1.1 to 1.4.

7. The medical monitor of claim 6, wherein the zinc phosphate glass powder has a true specific gravity of 2.45 to 2.55.

8. The medical monitor of claim 6, wherein the zinc phosphate glass powder has a bulk specific gravity of 0.78 to 0.82.

9. The medical monitor of claim 6, wherein the plastic resin comprises one selected from an acrylonitrile butadiene styrene (ABS) copolymer resin, a polypropylene (PP) resin and a polycarbonate (PC) resin.

10. The medical monitor of claim 6, wherein the zinc phosphate glass powder has an average particle size of 3 to 5 μm and a maximum particle diameter of 10 to 20 μm.
